(19) United States
(12) Patent Application Publication
(10) Pub. No.: US 2009/0129998 A1
(43) Pub. Date: May 21, 2009

(54) Apparatus for Integrated Heavy Oil Upgrading

(76) Inventors: Robert S Haizmann, Rolling Meadows, IL (US); James F. McGehee, Mount Prospect, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/942,401

(22) Filed: Nov. 19, 2007

(51) Int. Cl. B01J 8/04

(52) U.S. Cl. 422/190

(57) ABSTRACT

An apparatus is disclosed for converting heavy hydrocarbon feed into lighter hydrocarbon products. The heavy hydrocarbon feed is slurried with a particulate solid material to form a heavy hydrocarbon slurry and hydrocracked to produce vacuum gas oil (VGO). A light portion of the VGO may be hydrotreated and subjected to fluid catalytic cracking to produce fuels such as gasoline. A heavy portion of the VGO may be recycled to the slurry hydrocracking reactor. FCC slurry oil may be recycled to the slurry for hydrocracking.

### BACKGROUND OF THE INVENTION

This invention relates to a process and apparatus for the treatment of crude oils and, more particularly, to the hydroconversion of heavy hydrocarbons in the presence of additives and catalysts to provide useable products and further prepare feedstock for refining in a fluid catalytic cracking (FCC) unit.

Hydroconversion processes for the conversion of heavy hydrocarbon oils to light and intermediate naphthas of good quality and for reforming feedstocks, fuel oil and gas oil are well known. These heavy hydrocarbon oils can be such materials as petroleum crude oil, atmospheric tower bottoms products, vacuum tower bottoms products, heavy cycle oils, shale oils, coal derived liquids, crude oil residuum, topped crude oils and the heavy bituminous oils extracted from oil sands. Of particular interest are the oils extracted from oil sands and which contain wide boiling range materials from naphthas through kerosene, gas oil, pitch, etc., and which contain a large portion of material boiling above 524° C.

These heavy hydrocarbon feedstocks may be characterized by low reactivity in visbreaking, high coking tendency, poor conversion in hydrocracking and difficulties in distillation. They may have, in general, a low ratio of polar aromatics to asphaltenes and poor reactivity in a hydrocracking environment relative to aromatic feedstocks. Most residual oil feedstocks which are to be upgraded contain some level of asphaltenes. Asphaltenes are typically understood to be heptane insoluble compounds as determined by ASTM D3279 or ASTM D6560. Asphaltenes are high molecular weight compounds containing heteroatoms which impart polarity. It is known, for example, that asphaltenes can self-associate and lose solubility when there is a lack of other stabilizing species. As described by E. Hong and P. Watkinson, FUEL, 83, 1881-1887 (October, 2004), one parameter which may indicate lack of stability is the colloidal instability index (CII):

CII=(saturates+asphaltenes)/(polar aromatics+resins)

A higher value of CII indicates a greater tendency to precipitate to coke and, hence, more difficulty in the primary conversion operation.

As the reserves of conventional crude oils decline, these heavy oils must be upgraded to meet the demands. In this upgrading, the heavier materials are converted to lighter fractions and most of the sulfur, nitrogen and metals must be removed. Crude oil is typically first processed in a crude distillation tower to provide fuel products including naphtha, kerosene and diesel. Atmospheric gas oil is removed from a lower side cut for feed to an FCC unit. The crude bottoms stream is typically taken to a vacuum distillation tower to obtain vacuum gas oil (VGO) that can be feedstock for an FCC unit or other uses. The bottoms of the vacuum tower must be processed in a primary upgrading unit before it can be further processed into useable products. Primary upgrading units known in the art include, but are not restricted to, coking processes, such as delayed or fluidized coking, and hydrogen addition processes such as ebullated bed or slurry hydrocracking (SHC). As an example, the yield of liquid products, at room temperature, from the coking of some Canadian bitumens is typically about 55 to 60 wt-% with substantial amounts of coke as by-product. On similar feeds, ebullated bed hydrocracking typically produces liquid yields of 50 to 55 wt-%. U.S. Pat. No. 5,755,955 describes a SHC process which has been found to provide liquid yields of 75 to 80 wt-% with much reduced coke formation through the use of additives. All of these primary upgrading technologies such as delayed coking, ebullated bed hydrocracking and slurry hydrocracking enable conversion of crude oil vacuum bottoms to VGO boiling in the range of approximately 343 and 524° C. at atmospheric equivalent conditions. However, since this product VGO is hydrogen-deficient and high in sulfur and nitrogen contaminants it must be further hydroprocessed, cracked and/or reformed in order to produce useful transportation fuels.

During an SHC reaction, it is important to minimize coking. It has been shown by the model of Pfeiffer and Saal, PHYS. CHEM. 44, 139 (1940), that asphaltenes are surrounded by a layer of resins, or polar aromatics which stabilize them in colloidal suspension. In the absence of polar aromatics, or if polar aromatics are diluted by paraffinic molecules or are converted to lighter paraffinic and aromatic materials, these asphaltenes can self-associate, or flocculate to form larger molecules, generate a mesophase and precipitate out of solution to form coke. This coking can be minimized by the use of an additive or controlled by lowering reaction temperature. However, temperature reduction can also reduce conversion of poorer feeds. Adding a polar aromatic oil to the feedstock of a SHC is effective in reducing the coke formation as described in U.S. Pat. No. 5,755,955. Furthermore, U.S. Pat. No. 6,004,453 describes such SHC with recycle of both heavy gas oil and unconverted pitch to enable the operation of the unit at a higher conversion, thus facilitating upgrading.

FCC technology, now more than 60 years old, has undergone continuous improvement and remains the predominant source of gasoline production in many refineries. This gasoline, as well as lighter products, is formed as the result of cracking heavier (i.e. higher molecular weight), less valuable hydrocarbon feed stocks such as gas oil. In its most general form, the FCC process comprises a reactor that is closely coupled with a regenerator, followed by downstream hydrocarbon product separation. Hydrocarbon feed contacts fluidized catalyst in the reactor to crack the hydrocarbons down to smaller molecular weight products. During this process, coke accumulates on the catalyst, which must be burned off in the regenerator.

It would be desirable to maximize the feed rate of VGO from the primary upgrading unit to the FCC unit. However, a number of problems must be solved for the FCC unit to perform well with this type of feedstock. VGO produced in a primary upgrading unit contains high amounts of coke precursors which yield an abnormally high amount of coke in the FCC unit. More coke must then be burned in the catalyst regenerator of the FCC unit, which raises the regenerated catalyst temperature. Less of the hotter regenerated catalyst may be returned to the reactor thereby reducing feed conversion to gasoline. The primarily upgraded VGO also contains a low amount of gasoline precursors, so that the yield of FCC gasoline is low while the yield of undesirable FCC main column bottoms is high. In addition, the high content of nitrogen contaminants in the VGO also suppresses the cracking activity of the FCC catalyst which also lowers gasoline yield.

FCC slurry oil from the bottoms of an FCC main column typically contains FCC catalyst exceeding 1500 wppm, with particle size typically distributed between 1 to 50 μm. This exceeds the No. 6 fuel oil specification limit of 250 ppm. To meet this specification, refineries typically must dilute the heavy slurry oil with lighter, solids-free products that could otherwise be sold, thus reducing revenues. Refineries, alternatively, filter or settle the FCC catalyst out of the slurry oil requiring expensive equipment.

### SUMMARY OF THE INVENTION

We have found that integration of SHC and hydrotreating with FCC results in improved performance of all three processes. Heavy VGO from the SHC reactor and/or main column bottoms from the FCC unit are combined with the feed to the SHC unit. All lighter products of the SHC are processed in a hydrotreater. The hydrotreater process conditions and catalyst type are chosen so that the light VGO product from the SHC unit is hydrogenated, desulfurized and denitrified to the extent required to maximize or optimize gasoline yield, minimize coke make, and reduce SOx emissions in the FCC unit. The hydrotreated products may be fractionated into boiling ranges which include a VGO. The lighter, lower boiling VGO portion is sent to the FCC unit optionally along with other FCC feedstocks. The FCC main column bottoms may be returned to the SHC to undergo further conversion to VGO, naphtha and distillate.

### BRIEF DESCRIPTION OF THE DRAWINGS

For a better understanding of the invention, reference is made to the accompanying drawings.

FIG. 1 is a schematic flow scheme showing the apparatus of the present invention.

FIG. 2 is a schematic flow scheme showing an alternative apparatus of the present invention.

### DESCRIPTION OF THE PREFERRED EMBODIMENTS

The apparatus of this invention is capable of processing a wide range of heavy hydrocarbon feedstocks. It can process aromatic feedstocks, as well as feedstocks which have traditionally been very difficult to hydroprocess, e.g. vacuum bottoms, visbroken vacuum residue, deasphalted bottom materials, off-specification asphalt, sediment from the bottom of oil storage tanks, etc. Suitable feeds include atmospheric residue boiling at about 650° F. (343° C.), heavy vacuum gas oil (VGO) and vacuum residue boiling at about 800° F. (426° C.) and vacuum residue boiling above about 950° F. (510° C.). Throughout this specification, the boiling temperatures are understood to be the atmospheric equivalent boiling point (AEBP) as calculated from the observed boiling temperature and the distillation pressure, for example using the equations furnished in ASTM method D1160. Furthermore, the term “pitch” is understood to refer vacuum residue, or material having an AEBP of greater than about 975° F. (524° C.).

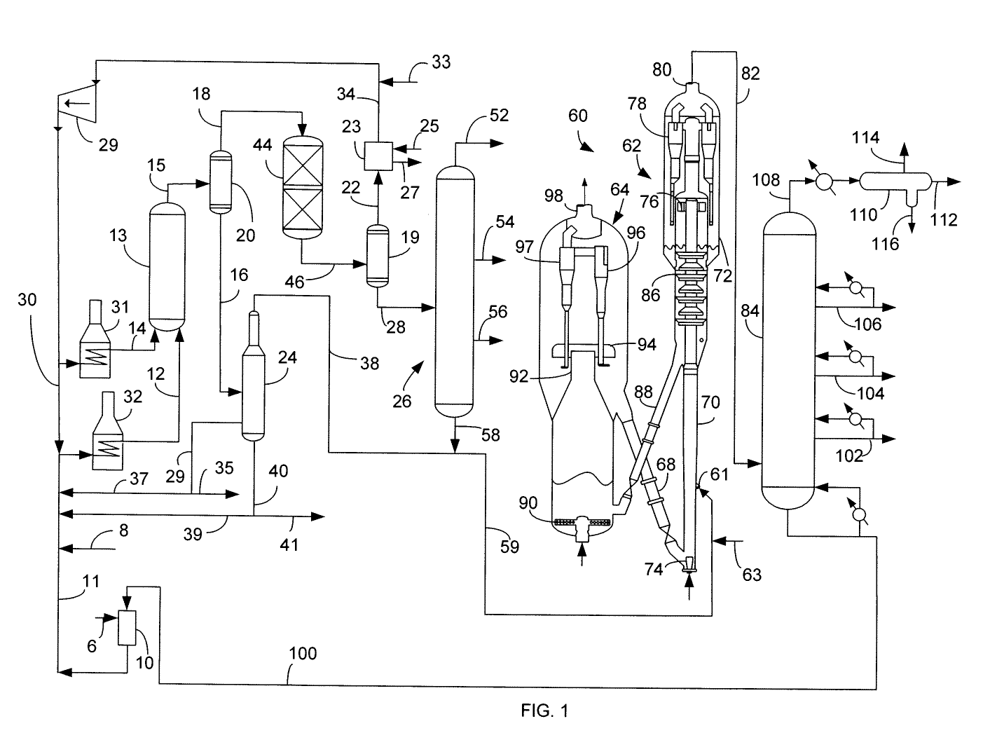

In the SHC apparatus as shown in FIG. 1, a coke-inhibiting additive of particulate material in line 6 is mixed together with a heavy hydrocarbon oil feed in a feed tank 10 to form a slurry. A variety of solid additive particles can be used as the particulate material, provided these solids are able to survive the hydrocracking process and remain effective as part of the recycle. Particularly useful additive particles are those described in U.S. Pat. No. 4,963,247. Thus, the particles are typically ferrous sulfate having particle sizes less than 45 μm and with a major portion, i.e. at least 50% by weight, preferably having particle sizes of less than 10 μm. Iron sulfate monohydrate is the preferred additive. Preferably, 0.01 to 4.0 wt-% of coke-inhibiting additive particles based on fresh feedstock are added to the feed mixture. Oil soluble coke-inhibiting additives may be used alternatively or additionally. Oil soluble additives include metal naphthenate or metal octanoate, in the range of 50-1000 ppm based on fresh feedstock with molybdenum, tungsten, ruthenium, nickel, cobalt or iron.

This slurry in feed tank 10, heavy hydrocarbon feed in line 8, pitch recycle containing additive particles in line 39, recycled heavy VGO in line 37, and FCC main column bottoms in line 100 are pumped into a heater 32. The combined feed is heated in the heater 32 and pumped through an inlet line 12 into an inlet in the bottom of a tubular SHC reactor 13. In the heater 32, coke-inhibiting additives newly added from line 6 typically thermally decompose to smaller particles for increased dispersion. Some of the decomposition will take place in the SHC reactor 13. For example, iron sulfate monohydrate will convert to ferrous sulfide and have a particle size less than 0.1 or even 0.01 μm upon leaving heater 32. The SHC reactor 13 is essentially empty of particulate catalyst, particularly a catalyst bed, before feed enters the reactor 13. Many mixing and pumping arrangements may be suitable. For example, the FCC main column bottoms in line 100 may be mixed with the additive from line 6 and pumped into line 11 to which heavy hydrocarbon feed, pitch and heavy VGO are admixed. Any of the feeds may be mixed with the additive in tank 10. It is also contemplated that feed streams may be added separately to the SHC reactor 13. Recycled hydrogen and make up hydrogen from line 30 are fed into the SHC reactor 13 through line 14 after undergoing heating in heater 31. The hydrogen in line 14 may be added at a location above the feed in line 12. Both feed from line 12 and hydrogen in line 14 may be distributed in the SHC reactor 13 with an appropriate distributor. Additionally, hydrogen may be added to the feed in line 11 before it is heated in heater 32 and delivered to the SHC reactor in line 12. Preferably the recycled pitch stream in line 39 makes up in the range of about 5 to 15 wt-% of the feedstock to the SHC reactor 13, while the heavy VGO in line 37 makes up in the range of 5 to 50 wt-% of the feedstock, depending upon the quality of the feedstock and the once-through conversion level. The feed entering the SHC reactor 13 comprises three phases, solid coke-inhibiting additive, liquid hydrocarbon feed and gaseous hydrogen and vaporized hydrocarbon.

The apparatus of this invention can be operated at quite moderate pressure, preferably in the range of 3.5 to 24 MPa, without coke formation in the SHC reactor 13. The reactor temperature is typically in the range of about 350 to 600° C. with a temperature of about 400° to 500° C. being preferred. The LHSV is typically below about 4 h⁻¹ on a fresh feed basis, with a range of about 0.1 to 3 h⁻¹ being preferred and a range of about 0.3 to 1 h⁻¹ being particularly preferred. Although SHC can be carried out in a variety of known reactors of either up or downflow, it is particularly well suited to a tubular reactor through which feed and gas move upwardly. Hence, the outlet from SHC reactor 13 is above the inlet. Although only one is shown in the FIG. 1, one or more SHC reactors 13 may be utilized in parallel or in series. Because the liquid feed is converted to vaporous product, foaming tends to occur in the SHC reactor 13. An antifoaming agent may also be added to the SHC reactor 13, preferably to the top thereof, to reduce the tendency to generate foam. Suitable antifoaming agents include silicones as disclosed in U.S. Pat. No. 4,969,988.

During the SHC reaction, it is important to minimize coking. Adding a lower polarity aromatic oil to the feedstock reduces coke production. The polar aromatic material may come from a wide variety of sources. Aromatic oil can be a fractionated heavy VGO from the SHC unit 13 in line 37 or an FCC main column bottoms in line 100 from an FCC unit. The aromatic oil may even be obtained from the byproducts of lube oil manufacturing or from a waste material such as polystyrene waste.

A gas-liquid mixture is withdrawn from the top of the SHC reactor 13 through line 15. The liquid-gas mixture from the top of the SHC reactor 13 can be separated in a number of different ways. The effluent from the top of the SHC reactor 13 is preferably separated in a hot, high-pressure separator 20 kept at a separation temperature between about 200 and 470° C. (392 and 878° F.), preferably between about 320 and 450° C. (608 and 850° F.), and most preferably between about 330 and 399° C. (626 and 750° F.) and preferably at about the pressure of the SHC reaction. In the hot separator 20, the effluent from the SHC reactor 13 is separated into a gaseous stream 18 and a liquid stream 16. The liquid stream 16 contains heavy VGO.

The gaseous stream is the flash vaporization product at the temperature and pressure of the hot separator 20 and comprises between about 35 and 80 vol-% of the hydrocarbon product from the SHC reactor 13, preferably between about 50 and 70 vol-%. Likewise, the liquid stream is the flash liquid at the temperature and pressure of the hot separator. The gaseous stream is removed overhead from the separator 20 through line 18 while the liquid fraction is withdrawn at the bottom of the separator 20 through line 16.

The gaseous stream in line 18 typically contains lower concentrations of aromatic components than the liquid fraction in line 16. For example, the vapor fraction usually contains less than about 30 vol-%, preferably less than about 25 vol-%, and most preferably less than about 20 vol-% aromatic components. The vapor fraction is in need of further refining. Its component fractions contain contaminants and cannot be readily used as commercial products. However, by excluding the heavier distillate components, which remain in the hot separator liquid, the vapor fraction can be hydrotreated by relatively milder conditions to remove sulfur and nitrogen or also remove aromatic components if a jet fuel or diesel fuel products are desired. At the same time the sulfur and nitrogen levels in the naphtha range material can be lowered to less than 1 wppm at relatively lower severity hydroprocessing conditions.

The gaseous stream in line 18 is passed directly to a catalytic hydrotreating reactor 44 having a bed charged with hydrotreating catalyst. Additional hydrogen may be added to the stream in line 18. However, sufficient hydrogen may already be present in line 18, so as not to require additional hydrogen to be added to hydrotreating reactor 44. Suitable hydrotreating catalysts for use in the present invention are any known conventional hydrotreating catalysts and include those which are comprised of at least one Group VIII metal, preferably iron, cobalt and nickel, more preferably cobalt and/or nickel and at least one Group VI metal, preferably molybdenum and tungsten, on a high surface area support material, such as a refractory oxide. Suitable refractory oxides include alumina, silica-alumina, silica, titania, magnesia, zirconia, beryllia, silica-magnesia, silica-titania and other similar combinations. The catalyst can be made by conventional methods including impregnating a preformed catalyst support. Other methods include cogelling, comulling, or precipitating the catalytic metals with the catalyst support followed by calcination. Other suitable hydrotreating catalysts include zeolitic catalysts, as well as noble metal catalysts where the noble metal is selected from palladium and platinum. It is within the scope of the present invention that more than one type of hydrotreating catalyst be used in the same reaction vessel. Two or more catalyst beds and one or more quench points may be utilized in the reaction vessel or vessels. The Group VIII metal is typically present in an amount ranging from about 2 to about 20 wt-% and preferably from about 4 to about 12 wt-%. The Group VI metal will typically be present in an amount ranging from about 1 to about 25 wt-%, preferably from about 2 to about 25 wt-%. The preferred catalyst is nickel and molybdenum supported on alumina.

The gaseous stream is contacted with the hydrotreating catalyst at a temperature between about 200 and 600° C. (430 and 1112° F.), preferably between about 230 and 480° C. (446 and 896° F.), in the presence of hydrogen at a pressure between about 5.4 and 34.5 MPa (800 and 5000 psia), preferably between about 10.3 and 20.7 MPa (1500 and 3000 psia), most preferably between 12.1 and 17.2 MPa (1750 and 2500 psia). As a result of the hydrotreating, organic sulfur is converted to hydrogen sulfide and organic nitrogen is converted to ammonia. Some olefins and some aromatic compounds may be hydrogenated as well. The hydrotreated product from the hydrotreating reactor 44 is withdrawn through line 46.

The effluent from the hydrotreating reactor 44 in line 46 is delivered to a cool high pressure separator 19 which is preferably operated at lower temperature than the hot separator 20. Within the cool separator 19, the product is separated into a gaseous stream rich in hydrogen which is drawn off through the overhead in line 22 and a liquid hydrocarbon product which is drawn off the bottom through line 28. By using this type of separator, the outlet gaseous stream obtained contains mostly hydrogen with some impurities such as hydrogen sulfide, ammonia and light hydrocarbon gases.

The hydrogen-rich stream 22 may be passed through a packed scrubbing tower 23 where it is scrubbed by means of a scrubbing liquid in line 25 to remove hydrogen sulfide and ammonia. The spent scrubbing liquid in line 27 may be regenerated and recycled and is usually an amine. The scrubbed hydrogen-rich stream emerges from the scrubber via line 34 and is combined with fresh make-up hydrogen added through line 33 and recycled through recycle gas compressor 29 and line 30 back to reactor 13. The bottoms line 28 carries liquid hydrotreated product to a product fractionator 26.

The product fractionator 26 may comprise one or several vessels although it is shown only as one in FIG. 1. The product fractionator produces a C₄⁻ recovered in overhead line 52, a naphtha product stream in line 54, a diesel stream in line 56 and a light VGO stream in bottoms line 58.

A liquid portion of the product from the hot separator 20 is used to form the recycle stream to the SHC reactor 13 after secondary treatment. Thus, the portion of the heavy VGO product from the hot separator 20 being used for recycle is fractionated in a liquid fractionation column 24. Line 16 introduces the liquid fraction from the hot high pressure separator 20 preferably to a vacuum distillation column 24 maintained at a pressure between about 1.7 and 10.0 kPa, preferably between about 3.4 and 6.7 kPa and at a vacuum distillation temperature resulting in an atmospheric equivalent cut point between light VGO and heavy VGO of between about 250 and 500° C. (482 and 932° F.), preferably between about 300 and 450° C. (572 and 842° F.), and most preferably between about 350 and 400° C. (662 and 752° F.). Three fractions may be separated in the liquid fractionation column: an overhead fraction of light VGO in an overhead line 38, a heavy VGO stream from a side cut in line 29 and a pitch stream obtained in a bottoms line 40 which boils above 450° C. This pitch stream preferably boils above 495° C. with a pitch boiling above 524° C. being particularly preferred. At least a portion of this pitch stream may be recycled back in line 39 to form part of the feed slurry to the SHC reactor 13. Remaining additive particles from SHC reactor 13 will be present in the pitch stream and conveniently recycled back to the SHC reactor 13. Any remaining portion of the pitch stream is recovered in line 41. The heavy VGO fraction boiling above 400° C. removed from the distillation column in line 29 may be split between line 37 which is recycled back to form part of the feedstock to the SHC reactor 13 and line 35 from which heavy VGO may be recovered. This heavy VGO typically contains the highest portion of polar aromatics. The light VGO in line 38 boils below about 400° C. and typically above about 300° C. The light VGO in line 38 may be combined with light VGO in the bottoms stream 58 and sent to an FCC unit 60 in line 59 to be cracked to desirable fuel or other products lighter than VGO.

The FCC unit 60 includes a reactor 62 and a catalyst regenerator 64. Suitable catalysts are those typically used in the art of fluid catalytic cracking, such as an active amorphous clay-type catalyst and/or a high activity, crystalline molecular sieves. Molecular sieve catalysts are preferred over amorphous catalysts because of their much-improved selectivity to desired products. Zeolites are the most commonly used molecular sieves in FCC processes. A large pore zeolite, such as an Y-type zeolite, bound on an active alumina material is preferred. Process variables typically include a cracking reaction temperature of about 400 to about 600° C. and a catalyst regeneration temperature of about 500 to about 900° C. Both the cracking and regeneration occur at an absolute pressure below about 0.5 MPa. The light VGO stream in line 59 and optionally other FCC co-feed in line 63 are distributed by distributor 61 and contacted with a stream of fluidized, newly regenerated hot cracking catalyst entering from a regenerated catalyst standpipe 68. This contacting may occur in a narrow reactor riser 70, extending upwardly to the bottom of a reactor vessel 72. The even contacting of feed and catalyst may be assisted by gas such as steam from a fluidizing gas distributor 74. Heat from the regenerated catalyst vaporizes the VGO, and the VGO is thereafter cracked to lighter molecular weight hydrocarbons in the presence of the catalyst as both are transferred up the reactor riser 70 into the reactor vessel 72. The cracked light hydrocarbon products are thereafter separated from the cracking catalyst using cyclonic separators which may include a rough cut separator 76 and one or two stages of cyclones 78 in the reactor vessel 72. Product gases exit the reactor vessel 72 through a product outlet 80 to line 82 for transport to a downstream FCC main fractionation column 84. Inevitable side reactions occur in the reactor riser 70 leaving coke deposits on the catalyst that lower catalyst activity. The spent or coked catalyst requires regeneration for further use. Coked catalyst, after separation from the gaseous product hydrocarbon, falls into a stripping section 86 where steam or other inert gas is injected through a nozzle to counter-currently purge any residual hydrocarbon vapor from the coked catalyst. After the stripping operation, the coked catalyst is fed to the catalyst regenerator 64 through a spent catalyst standpipe 88.

FIG. 1 depicts a regenerator 64 of the type known as a combustor. However, other types of regenerators are suitable. In the catalyst regenerator 64, a stream of oxygen-containing gas, such as air, is introduced through an air distributor 90 to contact the coked catalyst, burn coke deposited thereon, and provide regenerated catalyst and flue gas. The catalyst regeneration process adds a substantial amount of heat to the catalyst, providing energy to offset the endothermic cracking reactions occurring in the reactor riser 70. Catalyst and air flow upwardly together along a combustor riser 92 located within the catalyst regenerator 64 and, after regeneration, are initially separated by discharge through a disengager 94. Finer separation of the regenerated catalyst and flue gas exiting the disengager 94 is achieved using first and second stage separator cyclones 96 and 97, respectively, within the catalyst regenerator 64. Catalyst separated from flue gas dispenses through respective diplegs from cyclones 96, 97 while flue gas relatively lighter in catalyst sequentially exits cyclones 96, 97 and exits the regenerator vessel 64 through flue gas outlet 98. Regenerated catalyst is recycled back to the reactor riser 70 through the regenerated catalyst standpipe 68. As a result of the coke burning, the flue gas vapors exiting at the top of the catalyst regenerator 64 through outlet 98 contain CO, CO₂ and H₂O, along with smaller amounts of other species.

The gaseous FCC product in line 82 is directed to a lower section of an FCC main fractionation column 84. Several fractions may be separated and taken from the main column including a main column bottoms in line 100, a heavy cycle oil stream in line 102, a light cycle oil in line 104 and a heavy naphtha or gasoline stream in line 106. Any or all of lines 100, 102, 104 or 106 may be cooled and pumped back to the main column 84 to cool the main column typically at a higher location. Gasoline and gaseous light hydrocarbons are removed in overhead line 108 from the main column 84 and condensed before entering a main column receiver 110. A condensed water stream 116 is removed from a boot in the receiver 110. Moreover, a condensed light naphtha or gasoline stream is removed in line 112 while a gaseous light hydrocarbon stream is removed in line 114. Both streams in lines 112 and 114 may enter a gas concentration section to separate and recover debutanized gasoline and lighter products. The main column bottom stream in line 100 typically boils at or above about 343° C. (650° F.).

The main column bottoms in line 100 contains FCC catalyst typically exceeding 1500 ppm, with particle size typically distributed between 1 to 50 microns, exceeding the No. 6 fuel oil specification limit of 250 wppm. To meet this specification, refineries typically must dilute the heavy slurry oil with lighter, solids-free saleable products or filter or settle the FCC catalyst out of the slurry oil with expensive equipment. The embodiment of FIG. 1 allows the FCC slurry oil to be recycled in line 100 to the SHC reactor 13 without the need of diluting or removing FCC catalyst. The FCC catalyst acts as a secondary additive within the SHC reactor 13, minimizing coke precipitation and reducing the consumption rate of the primary coke-inhibiting additive. The particle size of the FCC catalyst in the FCC slurry oil enables it to be readily transported through the SHC reactor 13 without accumulating within the reactor. Thus, the FCC slurry oil with FCC catalyst fines and with SHC coke-inhibiting additive pass through the SHC reactor 13, into the liquid line 16, to the liquid fractionation column 24 then to the bottoms line 40 as pitch to be recycled in line 39 or recovered in line 41.

The integration of the FCC unit 60 in downstream communication with the hydrotreater 44 which is in downstream communication with the SHC reactor 13 allows heavy VGO from the SHC reactor 13 and main column bottoms from the FCC unit 60 to be combined with heavy hydrocarbon feed such as vacuum residue to form the feed to the SHC reactor 13. Light VGO product of the SHC reactor 13 may be hydrogenated, desulfurized and denitrified to the extent required for optimal or maximum gasoline yield, minimal coke make, and reduced SOx emissions from the flue gas in the FCC unit 60. The hydrotreated products are fractionated and the light VGO may be sent to the FCC unit 60 along with other FCC feedstocks in line 63.

The extent of the total feed to the FCC unit 60 that is hydrotreated is a variable which may be chosen by the operator based on his individual economic targets. Some or all of the light VGO product from the SHC reactor 13 may be hydrotreated. In the embodiment of FIG. 1 only the gaseous fraction in line 18 is hydrotreated. Optionally, all or part of the light VGO stream leaving the liquid fractionation column 24 may be hydrotreated.

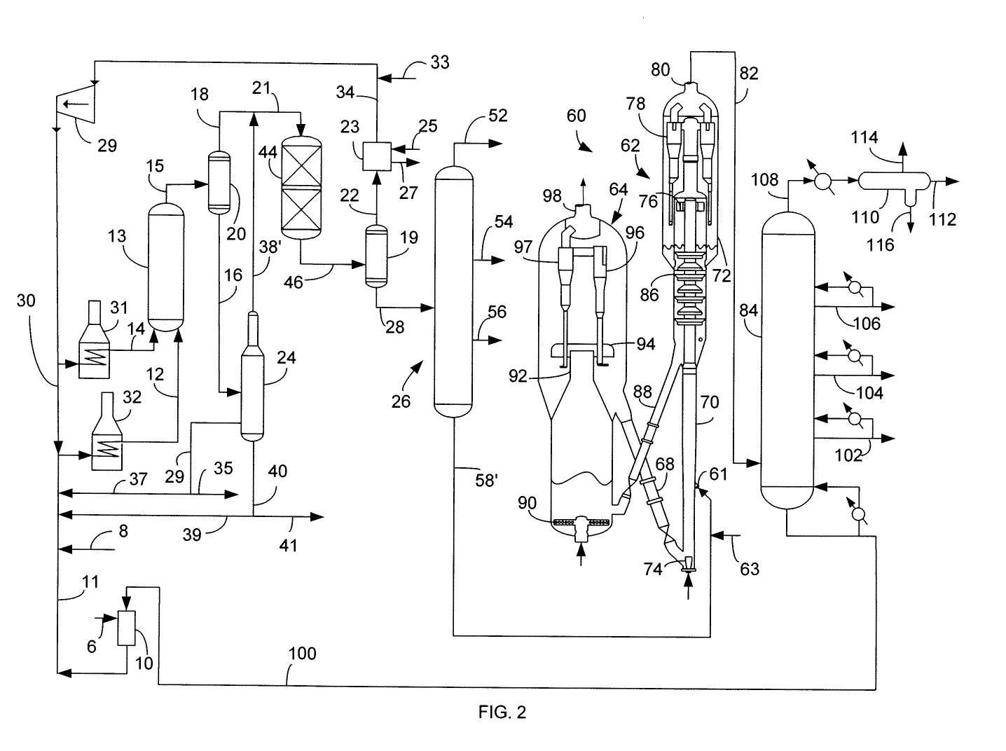

FIG. 2 depicts an alternative flowscheme of the present invention. FIG. 2 is the same as FIG. 1 with the exception that the overhead line 38 carrying the light VGO from the liquid fractionation column 24 is provided as feed to the hydrotreating reactor 44. For example, the light VGO in line 38 may be heated and pumped for admixture with the gaseous stream in line 18 to provide a mixed stream in line 21 that feeds hydrotreating reactor 44. The hydrotreated VGO in effluent line 46 is separated from gases in cool separator 19 and fed to the product fractionator 26. The hydrotreated VGO exits the product fractionator in line 58 and is fed to the FCC unit 60. In this alternate embodiment, all of the light VGO product of SHC reactor 13 which feeds the FCC unit 60 is subjected to hydrotreating. This may be particularly preferred in cases in which a relatively contaminated stream in line 63 co-feeds the FCC unit 60. All other aspects of the embodiment of FIG. 2 are the same as FIG. 1. It is also contemplated that a portion the overhead stream in line 38 is admixed with line 18 and the remainder is directed to the FCC unit without undergoing hydrotreating.

The combination of recycling the heavy VGO product of slurry hydrocracker 13 for further conversion and hydrotreating some or all of the light VGO product of slurry hydrocracker 13, prevents increasing the concentration of multiple ring aromatics that will end up in the FCC main column bottoms stream 100. Since this stream is relatively more difficult to convert, it would result in excess accumulation, higher liquid traffic and ultimately loss of conversion in the SHC reactor 13. Further, by the practice of our invention, this return stream in line 100 of main column bottoms is maintained at a controllable, steady-state level which helps stabilize asphaltenes, enabling the SHC reactor 13 to be operated at higher conversion severity without fear of precipitation. In this way, a surprisingly synergistic effect between the FCC unit 60 and the SHC reactor 13 is realized.

Other modes of operation are contemplated. For example, the co-feed 63 to the FCC reactor 62 may be heated and admixed with the stream in line 18 which is hydrotreated in hydrotreating reactor 44. In so doing, the high level thermal energy contained in the streams leaving SHC reactor 13 are used advantageously to minimize the amount of further energy needed to hydrotreat the FCC co-feed 63. Even more advantageously, the bottoms stream 58 or 58′ which leaves the product fractionator 26 now contains a greater percentage of the total feed to the FCC reactor 62. Since stream 58 or 58′ is hot, this thermal energy helps to satisfy the heat required of the endothermic reactions in reactor riser 70.

1. An apparatus for converting heavy hydrocarbon feed into lighter hydrocarbon products comprising:
a slurry hydrocracking reactor for contacting said heavy hydrocarbon feed with hydrogen and a particulate solid material;
a hydrotreating reactor in downstream communication with said slurry hydrocracking reactor for contacting product from said slurry hydrocracking reactor with hydrogen and hydrotreating catalyst;
a fluid catalytic cracking reactor in downstream communication with said hydrotreating reactor for cracking product from the hydrotreating reactor with fluidized catalyst to produce gasoline;
a main fractionation column in downstream communication with said fluid catalytic cracking reactor for separating a main column bottoms stream; and
said slurry hydrocracking reactor being in downstream communication with said main fractionation column.

2. The apparatus of claim 1 wherein said slurry hydrocracking reactor has an inlet below its outlet.

3. The apparatus of claim 1 wherein a hot separator is in downstream communication with said slurry hydrocracking reactor for separating product from said slurry hydrocracking reactor into a gaseous stream and a liquid stream, said gaseous stream exiting in an overhead and said liquid stream exiting in a bottoms of said separator.

4. The apparatus of claim 3 wherein said hydrotreating reactor is in downstream communication with said overhead of said hot separator and a liquid fractionation column is in downstream communication with said bottoms of said hot separator.

5. The apparatus of claim 4 wherein said FCC reactor is in downstream communication with an overhead of said liquid fractionation column.

6. The apparatus of claim 5 wherein said hydrotreating reactor is downstream of said overhead of said liquid fractionation column and said fluid catalytic cracking reactor is downstream of said hydrotreating reactor.

7. The apparatus of claim 6 wherein said slurry hydrocracking reactor is in downstream communication with a side cut or a bottoms of said liquid fractionation column.

8. The apparatus of claim 1 wherein a product fractionator is in downstream communication with said hydrotreating reactor and said FCC reactor is in downstream communication with a bottoms of said product fractionator.

9. An apparatus for converting heavy hydrocarbon feed into lighter hydrocarbon products comprising:
a slurry hydrocracking reactor for contacting said heavy hydrocarbon feed with hydrogen and a particulate solid material;
a separator in downstream communication with said slurry hydrocracking reactor for separating product from said slurry hydrocracking reactor into a gaseous stream and a liquid stream;
a hydrotreating reactor in downstream communication with an overhead of said separator for contacting said gaseous stream with hydrogen and hydrotreating catalyst;
a liquid fractionation column in downstream communication with a bottoms of said separator for fractionating said liquid stream into components; and
a fluid catalytic cracking reactor in downstream communication with said hydrotreating reactor and an overhead of said liquid fractionation column for cracking product from the hydrotreating reactor and light VGO from said liquid fractionation column with fluidized catalyst to produce gasoline.

10. The apparatus of claim 9 wherein a main fractionation column is in downstream communication with said fluid catalytic cracking reactor for separating a slurry oil in a bottoms stream and said slurry hydrocracking reactor is in downstream communication with a bottoms of said main fractionation column.

11. The apparatus of claim 10 wherein said slurry hydrocracking reactor is in downstream communication with a side stream of said liquid fractionation column.
